(19) United States
(12) Patent Application Publication
(10) Pub. No.: US 2008/0236440 A1
(43) Pub. Date: Oct. 2, 2008

(54) TRANSPORTATION DEVICE

(76) Inventors: Hideyuki NAKAMURA, Kudamatsu-shi (JP); Seiichi HAYASHI, Kudamatsu-shi (JP); Takeshi KAWASAKI, Kudamatsu-shi (JP); Toshiharu MIYAMOTO, Kudamatsu-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/838,959

(22) Filed: Aug. 15, 2007

(30) Foreign Application Priority Data
Mar. 30, 2007 (JP) 2007-092504

(51) Int. Cl. B61F 19/04; B60R 19/02

(52) U.S. Cl. 105/392.5; 293/102

(57) ABSTRACT

The invention provides a shock absorbing structure capable of turning the function of the shock absorber on and off according to the level of shock during collision, thereby reducing the frequency of replacing shock absorbers. On a rear surface of a load operating unit 11 constituting a shock absorbing device 10A are attached a load transmitting shaft 12 and a shock absorber 13. The load transmitting shaft 12 is passed through the center of the shock absorber and is connected to a supporting unit 14 via a pin 15 that extends toward the radial direction. The rear end of the shock absorber 13 faces the supporting unit 14 with a clearance therebetween. The pin 15 has notched grooves 21 formed thereto. When small load is applied, the load is transmitted from the load operating unit 11 through the load transmitting shaft 12, the pin 15 and the supporting unit 14 to the main body, so that the load is not applied on the shock absorber 13. When large load is applied, the pin 15 breaks from where the notched grooves 21 are formed, by which the surface of the closing plate 17 collides against the supporting unit 14, so that the load is transmitted to the shock absorber 13 and the shock is absorbed effectively.

The present application is based on and claims priority of Japanese patent application No. 2007-92504 filed on Mar. 30, 2007, the entire contents of which are hereby incorporated by reference.

### BACKGROUND OF THE INVENTION

1. Field of the Invention

The present invention relates to transportation devices including railway vehicles such as railway cars or monorail cars and automobiles anticipated to receive shock by collision. The present invention specifically relates to transportation devices equipped with a shock absorbing device composed of a shock absorber formed of a material having superior shock absorption property for absorbing the shock occurring during collision.

2. Description of the Related Art

In a conventional railway car, a crushable zone for absorbing the shock received during collision is desirably disposed in the car body so as to ensure the safety of passengers and crew during collision. With respect thereto, Japanese Patent No. 3725043 (patent document 1) proposes providing shock absorbing devices at longitudinal end portions of the front car (including the rearmost car, the definition of which applies hereafter) and the intermediate cars, so as to receive the load applied to the ends of the car body during collision by absorbers disposed at endmost portions of the car body so as to relieve the shock.

According to the structure disclosed in patent document 1, the various levels of loads applied to the end portions of the car body are received by the shock absorbers disposed at endmost portions of the car body. Therefore, if the shock absorbers are designed to be easily collapsed by shock to absorb the shock effectively, the shock absorbers will receive load every time a minor collision occurs, according to which the shock absorbers must be replaced frequently, resulting in the hindrance of train operation and increase of costs. However, if the shock absorbers are designed to have a strong structure in order to overcome such drawback, the shock absorbing property may be deteriorated and the shock absorbers may not function effectively when a large collision occurs.

Therefore, the problem to be solved in a transportation device having a shock absorbing device is to realize an arrangement enabling the shock absorbing function of the shock absorbing device to be turned on and off according to the level of shock received during collision, so that the shock absorber will not exert its function in a minor collision.

### SUMMARY OF THE INVENTION

The object of the present invention is to provide a transportation device with a shock absorbing device capable of turning the function of the shock absorber on and off according to the level of shock received during collision and to prevent frequent replacement of the shock absorber.

The object mentioned above can be achieved by a transportation device having a shock absorbing device for absorbing shock, wherein the shock absorbing device is turned off so that load is not transmitted to the shock absorber when a small load is applied, and the shock absorbing device is turned on so that load is transmitted to the shock absorber when a large load is applied to absorb the shock.

According to such arrangement, when the impact load is small, the load is not transmitted to the shock absorber, so that the load is not applied on the shock absorber and the shock absorber will not collapse. Therefore, compared to the prior art shock absorber that collapsed each time shock is applied, the costs and work related to replacing shock absorbers and to attach new absorbers can be cut down.

When the impact load is great, the load is applied on the shock absorber, by which the shock absorber is collapsed (function “on” state) to absorb shock.

### BRIEF DESCRIPTION OF THE DRAWINGS

FIG. 1A is a side view of a shock absorbing device according to one embodiment of the present invention;

FIG. 1B is an A-A cross-section of FIG. 1A;

FIG. 2 is cross-sectional view taken at line II-II of FIG. 1A;

FIG. 3 is a perspective view of the railway car body structure;

FIG. 4A is a side view of a shock absorbing device according to another embodiment of the present invention;

FIG. 4B is an A-A cross-section of FIG. 4A;

FIG. 5A is a side view of a shock absorbing device according to another embodiment of the present invention;

FIG. 5B is an A-A cross-section of FIG. 5A;

FIG. 6A is a side view of a shock absorbing device according to another embodiment of the present invention;

FIG. 6B is an A-A cross-section of FIG. 6A;

FIG. 7 is a cross-sectional view taken at line VII-VII of FIG. 6A;

FIG. 8A is a side view of a shock absorbing device according to another embodiment of the present invention;

FIG. 8B is an A-A cross-section of FIG. 8A;

FIG. 9 is a cross-sectional view taken at line IX-IX of FIG. 8A;

FIG. 10A is a side view of a shock absorbing device according to another embodiment of the present invention;

FIG. 10B is an A-A cross-section of FIG. 10A; and

FIG. 11 is a cross-sectional view taken at line XI-XI of FIG. 10A.

### DETAILED DESCRIPTION OF THE PREFERRED EMBODIMENTS

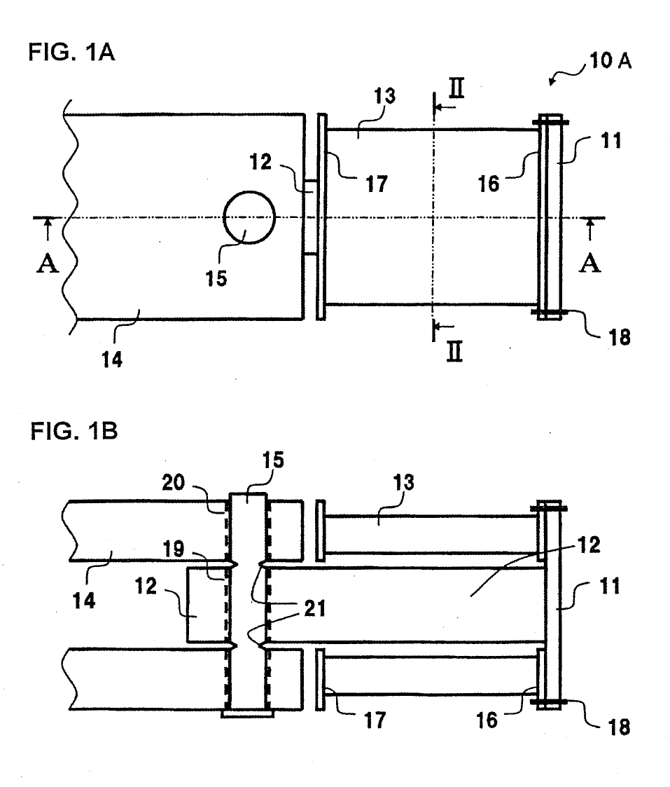

An embodiment of the present invention will be described with reference to FIGS. 1 through 3.

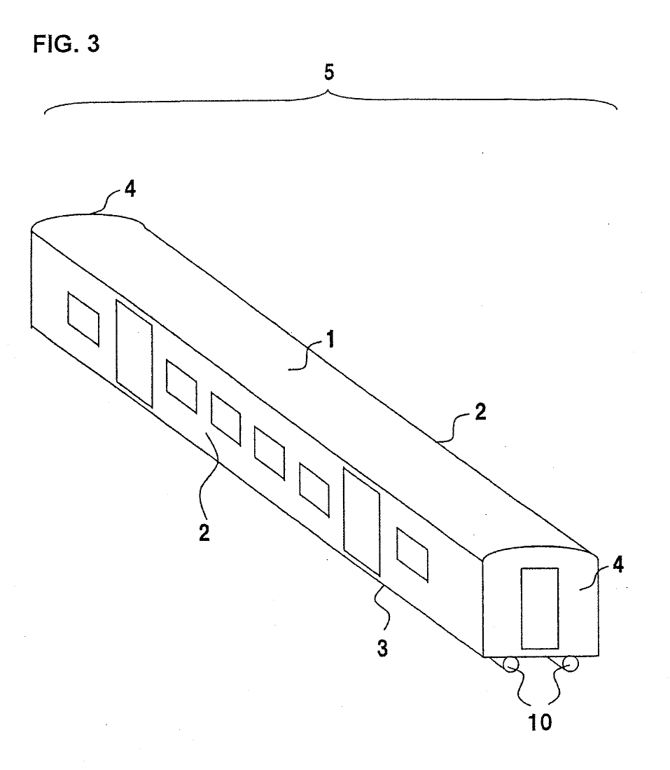

As illustrated in FIG. 3, a railway car body structure 5 is composed of a roof structure 1 constituting an upper plane thereof, two side structures 2 and 2 constituting the sides thereof, an underframe 3 constituting a lower plane thereof, and two end structures 4 and 4 constituting the ends thereof. The roof structure 1, the side structures 2 and 2, the underframe 3 and the end structures 4 and 4 are respectively formed by welding a plurality of extruded shape members. The extruded shape members constituting the roof structure 1, the side structures 2 and 2 and the underframe 3 are hollow shape members made of aluminum alloy, and the direction of extrusion thereof corresponds to the front-rear direction of the railway car body structure 5. The extruded shape members constituting the end structures 4 and 4 are shape members with ribs formed of aluminum alloy, and the direction of extrusion thereof corresponds to the height direction of the railway car body structure 5. On a lower surface of the underframe 3 at the longitudinal end portion of the railway car body structure 5 is disposed a shock absorbing device 10A disposed toward the longitudinal direction.

As illustrated in FIG. 1, the shock absorbing device 10A is composed of a load operating unit 11, a load transmitting shaft 12 functioning as a load transmitting member, a shock absorber 13, a supporting unit 14, and a connecting device connecting the load transmitting shaft 12 and the supporting unit 14.

The shock absorber 13 is a hollow extruded shape member having an octagonal cross-sectional shape formed of a material having superior shock absorbing property such as an A6063S-T5. The direction of operation of load with respect to the shock absorber 13 is right to left in FIG. 1. The shock absorber 13 is disposed so that the direction of extrusion of the hollow shape member corresponds to the load operating direction. A closing plate 16 is welded to a front end of the hollow extruded shape member, and a closing plate 17 is welded to the rear end thereof. Holes are formed respectively at the center of the closing plates 16 and 17 and the shock absorber 13 along the direction of shock or load operating direction, and the load transmitting shaft 12 is passed through the holes.

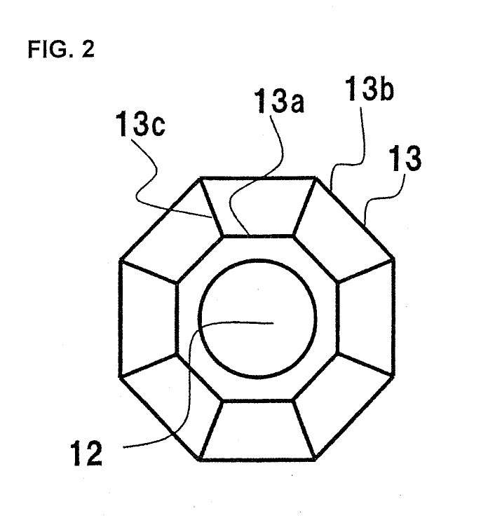

As illustrated in FIG. 2, the shock absorber 13 is composed of an inner cylinder 13a constituting the inner side of the octagon, an outer cylinder 13b constituting the outer side of the octagon, and multiple plates 13c connecting the inner and outer cylinders. The front end of the load transmitting shaft 12 passed through the inner side of the inner cylinder 13a is welded onto the rear surface of the load operating unit 11. The closing plate 16 at the front end of the shock absorber 13 is attached to the load operating unit 11 via bolts and nuts 18. The rear end of the shock absorber 13 faces the supporting unit 14 with a clearance therebetween.

The load operating unit 11 is the portion for receiving the impact load which is composed of a thick plate formed of aluminum alloy. The front side of the shock absorbing device 10A is the right side of FIG. 1.

Further, a supporting unit 14 is arranged at a rear end portion of the shock absorber 13. The supporting unit 14 is fixed to a lower surface of the underframe 3 of the railway car body structure 5. The supporting unit 14 is a member for connecting the shock absorber 13 to the underframe 3 of the railway car body structure 5. The supporting unit 14 is not necessarily collapsed by the impact load.

The front end portion (right side in FIG. 1) of the supporting unit 14 and the rear end portion (left side in FIG. 1) of the load transmitting shaft 12 is connected via a pin 15 penetrating the supporting unit 14 and the load transmitting shaft 12 in the radial direction. In the present embodiment, the pin 15 is the connecting device.

The pin 15 is passed through a hole 19 formed to the load transmitting shaft 12 and a hole 20 formed to the supporting unit 14. The pin 15 has notched grooves 21 formed on the outer surface thereof at positions corresponding to the outer-side surface of the load transmitting shaft 12 and the inner-side surface of the supporting unit 14. The pin 15 is designed to break easily at the portions where notched grooves 21 are formed when impact load is applied on the pin 15.

Furthermore, the front end surface of the supporting unit 14 has a substantially equivalent shape as the outer shape of the closing plate 17, and a clearance is formed between members 14 and 17.

According to such arrangement, the function of the shock absorber 13 is turned on and off depending on the level of shock received during collision.

That is, when a small load is applied, the load applied on the load operating unit 11 is not applied on the shock absorber 13, since the rear end of the shock absorber 13 is free from the supporting unit 14. This state is referred to as “off”.

On the other hand, when a large load is applied on the load transmitting shaft 12 and the pin 15 from the load operating unit 11, the pin 15 breaks at portions where notched grooves 21 are formed, and the load transmitting shaft 12 is inserted to the inner side of the supporting unit 14. This state in which the pin 15 is broken is referred to as “on”.

When the pin 15 breaks, the closing plate 17 collides against the front end portion of the supporting unit 14, and the load is transmitted to the shock absorber 13. Thus, the inner cylinder 13a, the outer cylinder 13b and the plural plates 13c that connect the inner cylinder 13a and the outer cylinder 13b of the shock absorber 13 collide against the supporting unit 14, and the shock absorber 13 is collapsed by being crushed into a bellows with many small bucklings, by which the shock is absorbed effectively.

According to such structure, when a small collision occurs and even if the pin 15 deforms, there is a clearance formed between members 14 and 17 so that the shock absorber 13 will not deform, and there will be no need to replace the shock absorber 13 even if the pin 15 must be replaced. This arrangement enables to prevent the occurrence of lack of ability of the shock absorber 13 when a major collision occurs.

Further according to the present invention, even after the occurrence of a major collision, the shock absorbing device 10A can be reconstructed by removing the bolts and nuts 18, and replacing the shock absorber 13 including the closing plates 16 and 17 and the pin 15.

Furthermore, it is also possible to adopt an arrangement in which the supporting unit 14 also collapses when a large load is applied so as to absorb such large load.

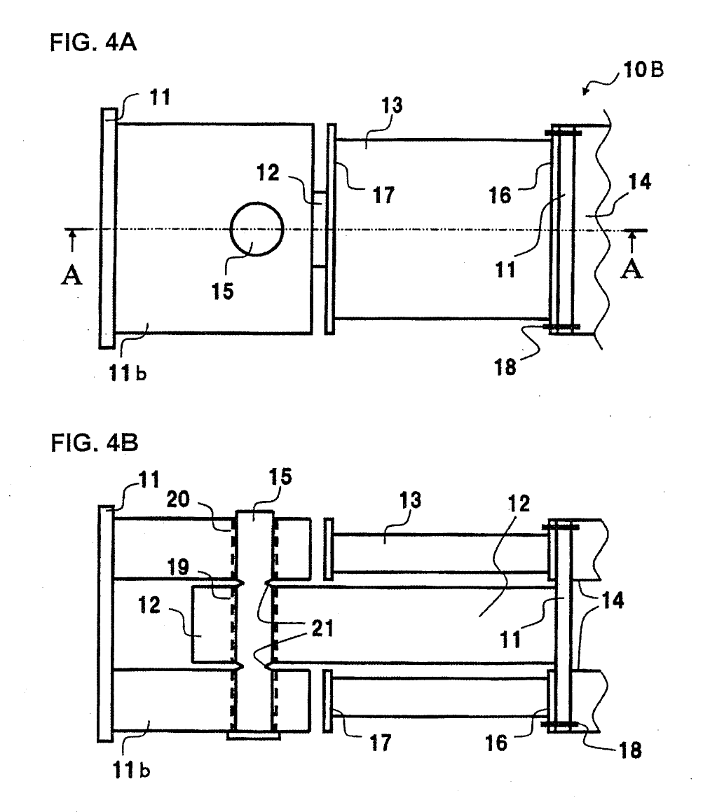

Next, another preferred embodiment of the present invention will be described with reference to FIG. 4. As for a shock absorbing structure 10B illustrated in FIG. 4, the components and members equivalent to the components and members of the embodiment illustrated in FIGS. 1 through 3 are denoted with the same reference numbers and the descriptions thereof are omitted. This applies to other preferred embodiments described hereafter. According to the present embodiment, the load operating unit 11 of the first embodiment illustrated in FIG. 1 functions as the supporting unit 14 for connecting the member to the main body, and the supporting unit 14 of FIG. 1 functions as the load operating unit. This is also applicable to the preferred embodiments described hereafter.

The shock absorbing device according to the embodiment illustrated in FIG. 4 is applicable to a cowcatcher of a transportation device such as a railway car, which is disposed between the underframe of a railway car and a railroad surface for removing obstacles on the railroad surface.

In FIG. 4, a load transmitting member 11b is protruded from a load operating unit 11 toward a shock absorber 13. The load transmitting member 11b and the shock absorber 13 are opposed to one another with a clearance therebetween. The load transmitting member 11b is welded to the load operating unit 11.

A load transmitting shaft 12 and the load transmitting member 11b are connected via a pin 15. The pin 15 has notched grooves 21 formed thereto which enable the pin to break easily by load.

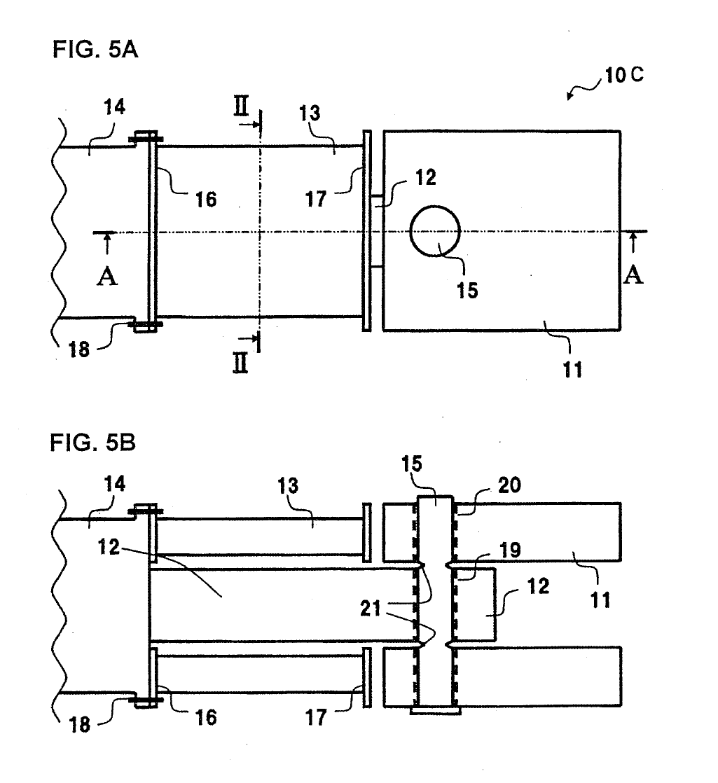

Yet another embodiment of the present invention will be described with reference to FIG. 5. A shock absorbing structure 10C illustrated in FIG. 5 corresponds to a variation of the embodiment illustrated in FIG. 1, wherein the supporting unit 14 and the closing plate 17 are welded together, a clearance is formed between the load operating unit 11 and the closing plate 16, and the pin 15 which is the connecting device of the load transmitting shaft 12 is disposed between the load operating unit 11.

According to such structure, a shock absorber 13 which is to be collapsed is welded to a supporting unit 14, so that the maintenance property after the occurrence of a major collision by which the shock absorber 13 collapses is somewhat deteriorated, but effects equivalent to those of the embodiment of FIG. 1 can be achieved. Of course, the shock absorber 13 can be connected to the supporting unit 14 via bolts and nuts. The axial direction of the bolts should correspond to the load operating direction. If bolts are used, the shock absorber can be replaced easily after receiving shock.

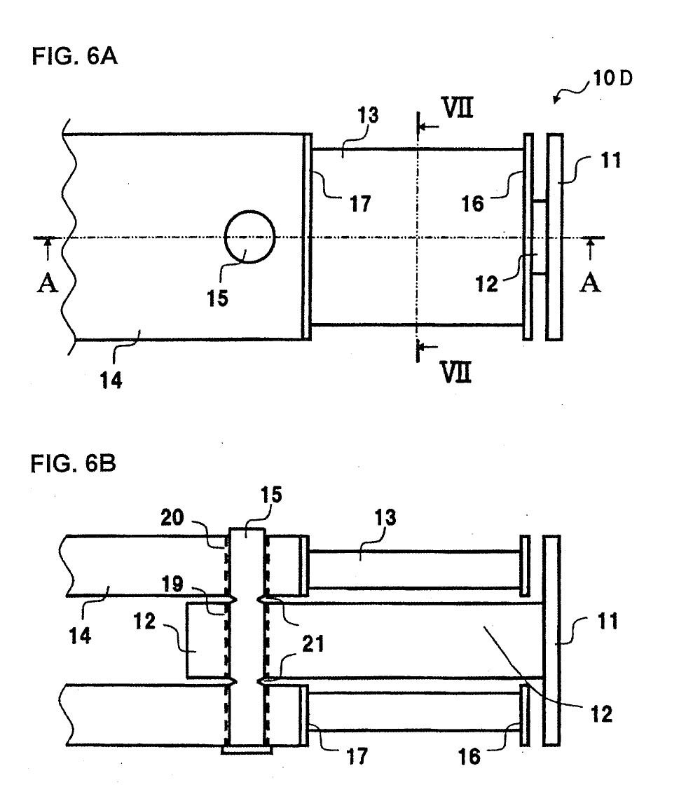

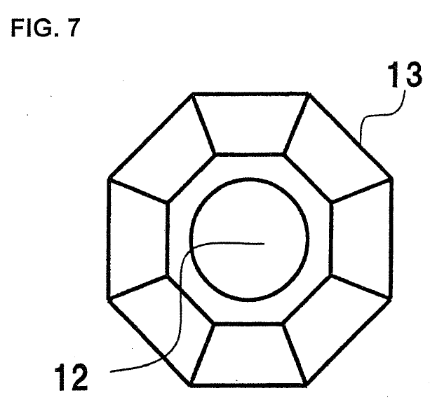

Yet another embodiment of the present invention is described with reference to FIGS. 6 and 7. A shock absorbing structure 10D illustrated in FIGS. 6 and 7 corresponds to a variation of the embodiment of FIG. 1, wherein the supporting unit 14 and the closing plate 17 are bonded via welding and a clearance is formed between the load operating unit 11 and the closing plate 16.

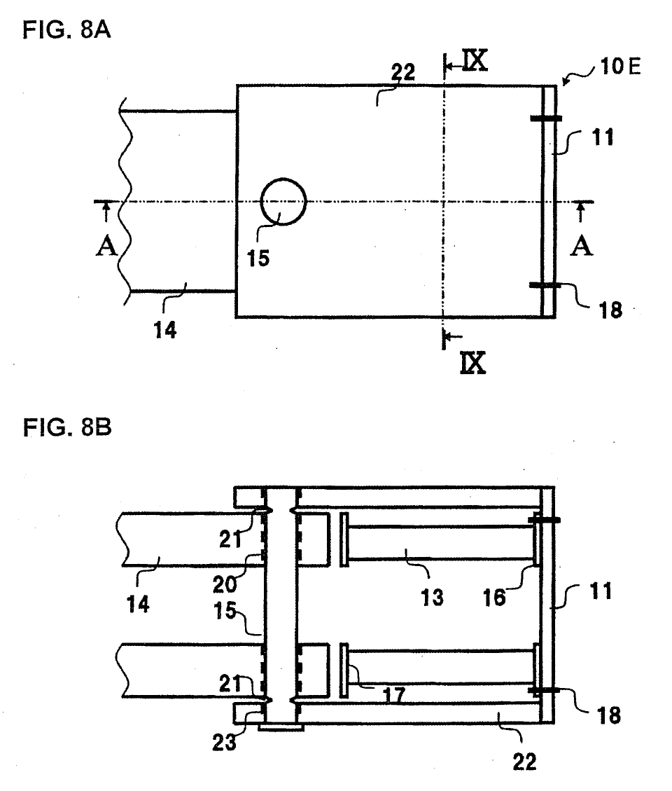

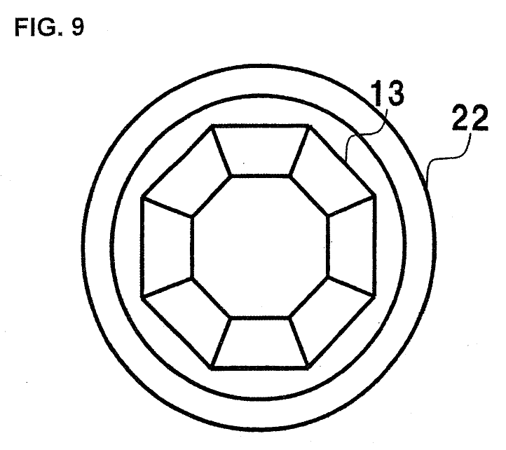

Another embodiment of the present invention will be described with reference to FIGS. 8 and 9. A shock absorbing structure 10E illustrated in FIGS. 8 and 9 has a cylindrical load transmitting cylinder 22 disposed as a load transmitting member instead of the load transmitting shaft 12 disposed to pass through the hollow portion of the shock absorber 13 in the embodiment of FIG. 1. The load transmitting cylinder 22 is welded to the load operating unit 11, covering the outer circumference of a shock absorber 13 and a portion of the outer circumference of the supporting unit 14 adjacent to the shock absorber 13.

The front end (right side of FIG. 8) of the supporting unit 14 and the rear end (left side of FIG. 8) of the load transmitting cylinder 22 is connected via a pin 15 penetrating the supporting unit 14 and the load transmitting cylinder 22 in the radial direction. The pin 15 is passed through a hole 23 formed to the load transmitting cylinder 22 and a hole 20 formed to the supporting unit 14. The pin 15 has notched grooves 21 formed to the outer surface at positions corresponding to the inner surface of the load transmitting cylinder 22 and the outer surface of the supporting unit 14. The pin 15 is designed to break easily at portions where notched grooves 21 are formed when the pin 15 receives impact load.

According to such arrangement, the external appearance is improved since the outer circumferences of the shock absorber 13 and the supporting unit 14 are covered with the load transmitting cylinder 22. Moreover, the present arrangement enables to reduce the shattering of small fragments of the shock absorber 13 collapsed by receiving a large load.

In the embodiment illustrated in FIGS. 8 and 9, the shock absorber 13 is opposed to the supporting unit 14 with a clearance therebetween, but it is also possible to adopt a design similar to the embodiment of FIG. 6 in which the shock absorber 13 is welded to the supporting unit 14 and a clearance is formed between the shock absorber 13 and the load operating unit 11.

If the connection between the shock absorber 13 and the load operating unit 11 or the supporting unit 14 is realized via bolts and nuts instead of welding, it becomes possible to replace the shock absorber 13 easily.

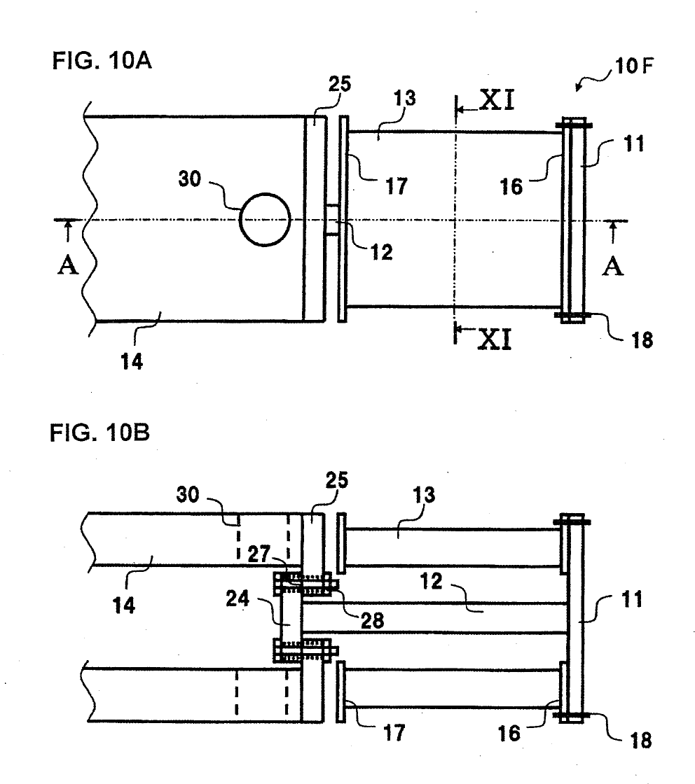

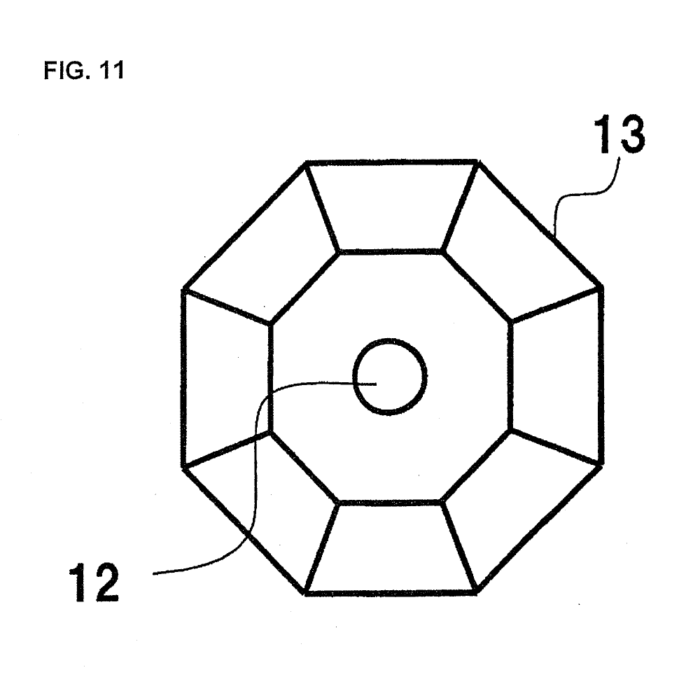

Another embodiment of the present invention will be described with reference to FIGS. 10 and 11. A shock absorbing structure 10F illustrated in FIGS. 10 and 11 corresponds to a variation of the embodiment of FIG. 1, wherein the load transmitting shaft 12 and the supporting unit 14 are connected not by a pin 15 but by bolts 27 and nuts 28 via connecting members 24 and 25. The rear end of the load transmitting shaft 12 is passed through the connecting member 24 and then welded to the connecting member 24. The welding is performed prior to fixing the supporting unit 14 to the lower surface of the underframe 3.

Furthermore, prior to fixing the supporting unit 14 to the lower surface of the underframe 3, bolts 27 are passed through a connecting member 25 welded to the front end of the supporting unit 14 and a connecting member 24 welded to the rear end of the load transmitting shaft 12, and the heads of bolts 27 are screw-engaged using a wrench through an opening 30. The nuts 28 of the bolts 27 are engaged using a wrench through the clearance formed between the supporting unit 14 and the closing plate 17.

According to this structure, when a collision applying a large load occurs, the bolts 27 break and the shock absorber 13 contacts the supporting unit 14, by which the impact is absorbed. According to this arrangement, it is necessary to replace only the shock absorber 13 including closing plates 16 and 17 and the bolts 27 and nuts 28, so costs can be reduced compared to when the pin 15, which is a processed product, must be replaced.

Moreover, since the tensile strength of the bolt 27 can be confirmed on a mill sheet obtained at the time of purchase, the quality of the shock absorbing device 10 can be stabilized.

What is claimed is:

1. A transportation device having a shock absorbing device with a shock absorber for absorbing shock, wherein
the shock absorbing device is turned off so that load is not transmitted to the shock absorber when a small load is applied, and the shock absorbing device is turned on so that load is transmitted to the shock absorber when a large load is applied to absorb the shock.

2. A transportation device having a shock absorbing device with a shock absorber for absorbing shock, wherein
the shock absorbing device is turned off so that load is not transmitted to the shock absorber when a small load is applied, and the shock absorbing device is turned on so that load is transmitted to the shock absorber when a large load is applied to absorb the shock; and
the shock absorbing device comprises a load operating unit for receiving impact load, a supporting unit disposed on a main body of the transportation device, a shock absorber disposed between the supporting unit and the load operating unit and connected to only either the supporting unit or the load operating unit and not connected to the other unit but opposed thereto with a clearance therebetween, a load transmitting member connected to the load operating unit and the supporting unit, and a connecting device for connecting the load transmitting member to either the load operating unit or the supporting unit.

3. The transportation device according to claim 2, wherein
the load transmitting member is composed of either a load transmitting shaft passing through an interior of the shock absorber and connected via the connecting device to the supporting unit, or a load transmitting cylinder surrounding the shock absorber and an outer circumference of the supporting unit and connected via the connecting device to the supporting unit.

4. The transportation device according to claim 2, wherein
the connecting device is a pin disposed in a radial direction of the load transmitting member when the load transmitting direction of the load transmitting member is defined as an axial direction.

5. The transportation device according to claim 2, wherein
the load transmitting member is composed of either a load transmitting shaft passing through an interior of the shock absorber and connected via the connecting device to the supporting unit, or a load transmitting cylinder surrounding the shock absorber and an outer circumference of the supporting unit and connected via the connecting device to the supporting unit;
the connecting device is a pin disposed in a radial direction of the load transmitting member when the load transmitting direction of the load transmitting member is defined as an axial direction; and
the pin has a notched groove formed on an outer circumference thereof at a portion positioned between the supporting unit and the load transmitting means.

6. The transportation device according to claim 2, wherein
the connecting device is a bolt and a nut connecting a rear end portion of the load transmitting member to a front end portion of the supporting unit disposed along a longitudinal direction of the load transmitting member.

7. The transportation device according to claim 2, wherein
the shock absorber and the load operating unit or the supporting unit are connected by a bolt and a nut.

8. The transportation device according to claim 2, wherein
the load operating unit is disposed as a cowcatcher of the transportation device, which is positioned between the transportation device and a road surface on which the transportation device runs; and
the shock absorber is turned on when large load is applied to the load operating unit and is collapsed to absorb the load.
